(19) United States
(12) Patent Application Publication
(10) Pub. No.: US 2008/0263389 A1
(43) Pub. Date: Oct. 23, 2008

(54) SYSTEM FOR MONITORING ENUM PERFORMANCE

(75) Inventors: BERNARD KU, AUSTIN, TX (US); MEHRAD YASREBI, AUSTIN, TX (US); JAMES JACKSON, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/738,385

(22) Filed: Apr. 20, 2007

(51) Int. Cl. G06F 11/00

(52) U.S. Cl. 714/4

(57) ABSTRACT

A system for monitoring tElephone NUmber Mapping (ENUM) performance is disclosed. A system that incorporates teachings of the present disclosure may include, for example, an ENUM system having a subsystem to monitor one or more operations of the ENUM system, and generate a fault notice responsive to detecting one or more faults in the operations monitored. Additional embodiments are disclosed.

### FIELD OF THE DISCLOSURE

The present disclosure relates generally to monitoring techniques, and more specifically to a system for monitoring tElephone NUmber Mapping (ENUM) performance.

### BACKGROUND

As large communication carriers migrate to an IP Multimedia Subsystem (IMS) based Voice over Internet Protocol (VoIP) using ENUM, a carrier grade ENUM system will be required that can provide desired characteristics such as scalability, fast response time, and overall efficient use of hardware and software resources to offer robust multimedia services. Presently, however, there are few means for evaluating such operational characteristics of the ENUM system in an IMS network, and even fewer means for ensuring reliable delivery of the multimedia services in the IMS network.

A need therefore arises for a system for monitoring ENUM performance.

### BRIEF DESCRIPTION OF THE DRAWINGS

FIG. 1 depicts an exemplary embodiment of a communication system;

FIG. 2 depicts an exemplary method operating in portions of the communication system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system for monitoring ENUM performance.

In a first embodiment of the present disclosure, a computer-readable storage medium can include at least one among a group of computer instructions for monitoring a response time to queries submitted to a Telephone Number Mapping (ENUM) system, a throughput of queries processed by the ENUM system, a maximum response time to queries submitted to the ENUM system, a minimum response time to queries submitted to the ENUM system, an average response time to queries submitted to the ENUM system, and utilization of resources of the ENUM system.

In a second embodiment of the present disclosure, a Telephone Number Mapping (ENUM) system can have a subsystem to monitor one or more operations of the ENUM system, and generate a fault notice responsive to detecting one or more faults in the operations monitored.

In a third embodiment of the present disclosure, a network element of an IP Multimedia Subsystem (IMS) network can have a controller element to monitor operations of a Telephone Number Mapping (ENUM) system.

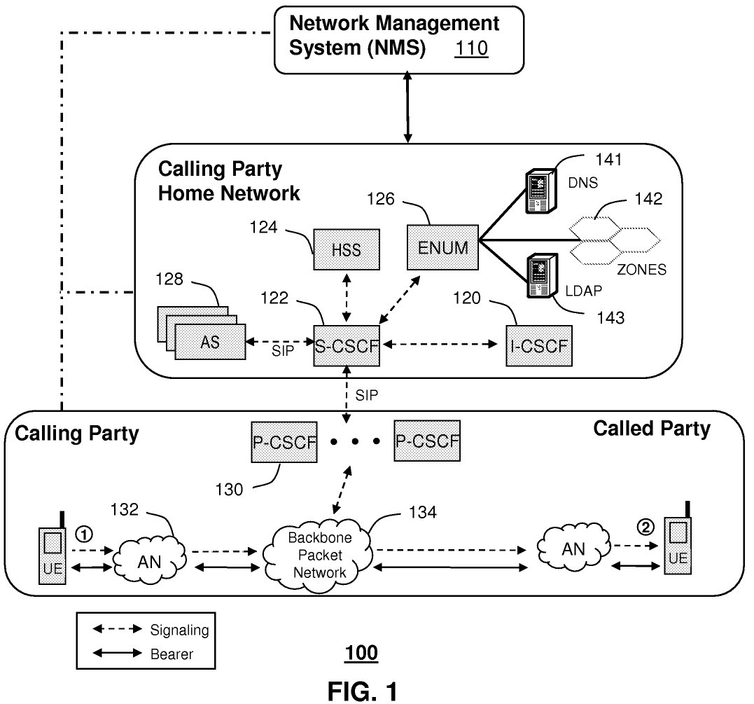

FIG. 1 depicts an exemplary embodiment of a communication system depicted as an IP Multimedia Subsystem (IMS) network 100. The IMS network 100 can comprise among other things a Proxy Call Session Control Function (P-CSCF) 130, an Interrogating CSCF (I-CSCF) 120, a Serving CSCF (S-CSCF) 122, a Home Subscriber Server (HSS) 124, an tElephone NUmber Mapping (ENUM) system 126, one or more Domain Name Service (DNS) servers 141, one or more lightweight directory access protocol (LDAP) servers 143 organized by zones 142, an Application Server (AS) 128, an Access Network (AN) 132, a backbone packet-switched network 134, and a plurality of IMS User Equipment (UE) devices denoted by the IMS UE 1 and IMS UE 2. The IMS UE devices can connect to networks, though not shown. Signaling and bearer activities are depicted by dashed versus solid lines between IMS terminal devices.

ENUM is a suite of protocols that is best suited to offer services that expand the means to complete calls over IP networks. ENUM accesses the DNS 141 to translate E.164 telephone numbers into IP addressing schemes (e.g. SIP, H323, or email) DNS 141 can be used to look up Internet addresses for services such as VoIP telephony. Naming Authority Pointer or NPTR records are used for translating E.164 addresses to SIP addresses. The LDAP servers 143 can store resource records (RRs) in an object-oriented format such as by classes and corresponding zones. With classes and zones, RRs can be organized by a country code, a Numbering Plan Area (NPA), and/or a Numeric Numbering Exchange (NXX). As an example, an ENUM record can be broken into a number of zones such as by country (country code “1”), NPA (“222”), and/or NXX (“333”).

A Network Management System (NMS) 110 utilizing common computing and communications technologies can be used to monitor and maintain a desired operational performance of the ENUM system 126. When the operational efficiency of the ENUM system is in question, the NMS 110 can apply mitigating steps to overcome predicted or detected faults.

A P-CSCF 130 can be a Session Initiation Protocol (SIP) proxy serving as a first point of contact to an IMS UE. An I-CSCF 120 is a SIP proxy that can among other things query the HSS 124 to retrieve IMS UE location and route SIP calls to its assigned S-CSCF 122. An S-CSCF 122 is a SIP server that can handle SIP registrations, which allows it to bind the IMS UE device.

The HSS 124 can serve as a master database that supports the IMS network 100 for processing calls. It can contain subscription information. It can also perform authentication and authorization of an IMS UE, and can provide information about the physical location of an IMS UE.

The ANs 132 support wireline or wireless access technologies including without limitation Bluetooth™, Wireless Fidelity (WiFi), Worldwide Interoperability for Microwave Access (WiMAX), Ultra Wide Band (UWB), and cellular access technologies such as CDMA-LX, W-CDMA/HSDPA, GSM/GPRS, TDMA/EDGE, and EVDO. IMS UEs can represent residential or commercial fixed line IMS terminals as well as portable IMS devices such as cellular phones conforming to an IMS standard. The packet-switched backbone 134 can represent a packet network supporting any number of protocols such as IP, Multi-Protocol Label Switching (MPLS), Asynchronous Transfer Mode/Frame Relay (ATM/FR), and so on.

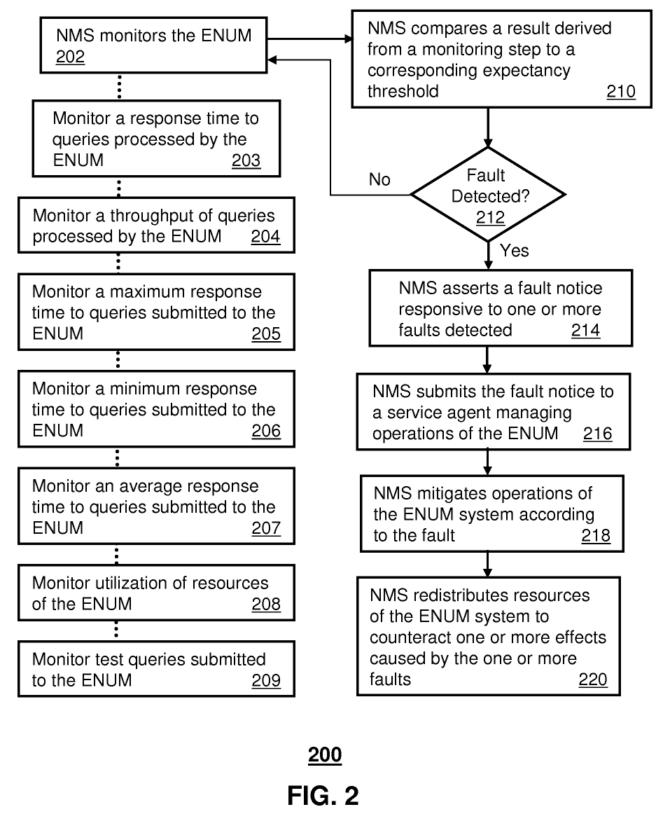

FIG. 2 depicts an exemplary method 200 to monitor ENUM performance. Method 200 can begin with step 202 in which the NMS 110 monitors the performance of the ENUM system 126. For instance, as shown in steps 203-209, the NMS 110 can monitor: a response time to queries submitted to the ENUM system 126, a maximum response time to queries submitted to the ENUM system, a minimum response time to queries submitted to the ENUM system, an average response time to queries submitted to the ENUM system, a utilization of resources of the ENUM system, and/or other suitable test queries submitted to the ENUM system.

The NMS 110 can perform any one of steps 203-209 to evaluate the performance of the ENUM system 126, and is not limited to the order, or number, of steps shown. It should also be noted, that the NMS 110 can delegate or direct one or more network elements of the IMS 100 system to perform in whole or in part steps 203-209. For example, the NMS 110 can direct an S-CSCF to perform one of the aforementioned monitoring steps with the ENUM system 126. The S-CSCF can collect telemetry data from these steps and supply this information to the NMS 110 when requested or periodically. Consequently, the S-CSCF can assist the NMS 110 to predict and/or detect degradations in the performance of the ENUM system 126 which can affect call set-up times among other things in the IMS network 100. The ENUM system 126 can also be directed to collect measurements such as those described by steps 203-209 and supply this information to the NMS 110 for analysis. From these embodiments, it would be evident to an artisan with ordinary skill in the art that any network element of the IMS network 100 can be directed by the NMS 110 assist in monitoring the performance of the ENUM system 126.

As part of the monitoring process, the NMS 110 can also create a performance and operation parameter set. The parameter set can identify, for example, one or more variables, such as an ENUM response time, with corresponding values. Each variable can have a benchmark value and an observed value. The benchmark value establishes an expectancy threshold for comparison against the observed value. The observed value can be specific to an ENUM service in the context of an IMS application. For example, the NMS 110 can benchmark a data throughput and latency, associated with an ENUM query for establishing a VoIP communication session. If an observed variable exceeds a benchmark value, the NMS 110 can, in response, generate a fault notice. The NMS 110 can continually update the parameter set to model the performance of the ENUM system 126 under various system load conditions for specific IMS applications. The NMS 110 can also generate tests from, for example, test scripts, which can be used, in conjunction with the aforementioned parameter set. These tests can be specific to an IMS application which may expose faults in an ENUM service.

As shown in step 210, the NMS 110 can compare results derived from at least one of the monitoring steps 203-209 or application specific tests mentioned above to a corresponding expectancy threshold. If a fault is detected at step 212 from one or more of these results exceeding its corresponding expectancy threshold, the NMS 110 at step 214 can assert a fault notice. The NMS 110 can then, as shown in step 216, submit the fault notice to a service agent managing operations of the ENUM system 126. The service agent can proceed to handle the fault or pass the fault notice to a network technician in the IMS network 100. The NMS 110 can also forward the fault notice to other network elements in the IMS network 100 to assist said devices in anticipating service interruptions and respond accordingly.

At step 218, the NMS 110 can be programmed to mitigate operations of the ENUM system 126 according to the fault notice. For instance, as shown in step 220, the NMS 110 can redistribute resources of the ENUM system 126 to counteract one or more effects caused by the detected faults. A resource can include one or more zones, one or more DNS servers, and one or more LDAP servers. For example, the NMS 110, in response to detecting an overload condition of the ENUM system 126, can horizontally distribute zones across one or more DNS servers 141, add zones vertically to DNS servers with excess capacity, add additional DNS servers 141, add LDAP servers 143, or generate a redistribution plan, to compensate for the overload condition.

The NMS 110 can also monitor a propagation delay between the calling party 1 in a first IMS network to the called party 2 in a second IMS network. The propagation delay includes a network delay associated with submitting an E.164 number translation query to the ENUM system 126, and receiving a SIP URI address therefrom, and a server query delay associated with translating the SIP URI to an IP address by way of the DNS server 141. If the observed propagation delay is greater than a benchmark value, the NMS 110 can identify a connection status between the S-CSCF and the ENUM. The following pseudo code demonstrates other embodiments that can be tested by the NMS 110:

```
If (No ENUM response) {
    Generate Alarm (“probable ENUM Server Cluster Manager or Cluster failure”,
    “Check ENUM load balancer and servers”).
}
If (OBS_PD (ENUM Query) > MAX_PD (ENUM_Query)) {
    Generate_Alarm (“Interface to the ENUM Server cluster is slow”, “Check other
    alarms”).
    Generate Test Message between S-CSCF and ENUM servers.
    If OBS_PD(Test Msg) > MAX_PD(Test_Msg)
        Generate Alarm (“probable S-CSCF<->ENUM Server IP connection
        failure”, “Check cables, interfaces, routers and interfaces”)
    Else
        Generate Alarm (“Problem with the ENUM Server Application”, “Check
        whether any of the number of ENUM Server applications are down”)
}
If (LMU > MAX_LMU OR LAU > MAX_LAU) {
        Generate Alarm (“probable disk capacity or failure”, “Check disks of the
        ENUM server(s) for being nearly full or experiencing I/O errors, paying special
        attention to WRITE errors”).
}
```

Definitions:

OBS_PD=Observed Propagation Delay

MAX_PD=Maximum Propagation Delay

MAX_LMU=Maximum Latency Time for Each Update

MAX_LAU=Maximum Average Latency Time for updates

In summary, method 200 can be implemented by the NMS 110, or any other IMS network element, to maintain a desired quality of service of the IMS network 100 by evaluating, reporting, and maintaining the performance of the ENUM system 126. The NMS 110 enables a carrier or service provider to apply testing metrics to an ENUM system 126 to perform proactive and forward-looking maintenance and configuration management in an IMS environment. As such the NMS 110 can predict by common means (e.g., regression analysis) a decrease in ENUM performance, identify faults in the ENUM system 126, and propose or automatically make changes to mitigate said deficiencies or faults in the ENUM system.

Upon reviewing the aforementioned embodiments, it would be evident to an artisan with ordinary skill in the art that said embodiments can be modified, reduced, or enhanced without departing from the scope and spirit of the claims described below. For example, automatic tests for monitoring performance variables of a parameter set in accordance with method 200 can be implemented in a back-office network operations center to enhance reliability of the IMS network 100. Performance benchmarks and tolerances of the parameter set can be established in a lab, or in the field. As an example, a benchmark parameter set for achieving a desired VoIP call set-up time can be defined based on existing data throughput conditions. The parameter set can be updated with performance variables specific to an IMS application. In yet another embodiment, the ENUM system 126 can be programmed to perform the above steps in whole or in part independent of the NMS 110. In this embodiment, the ENUM system 126 can be programmed to detect and/or predict faults, generate fault notices, and apply self-healing techniques to mitigating a degradation in performance.

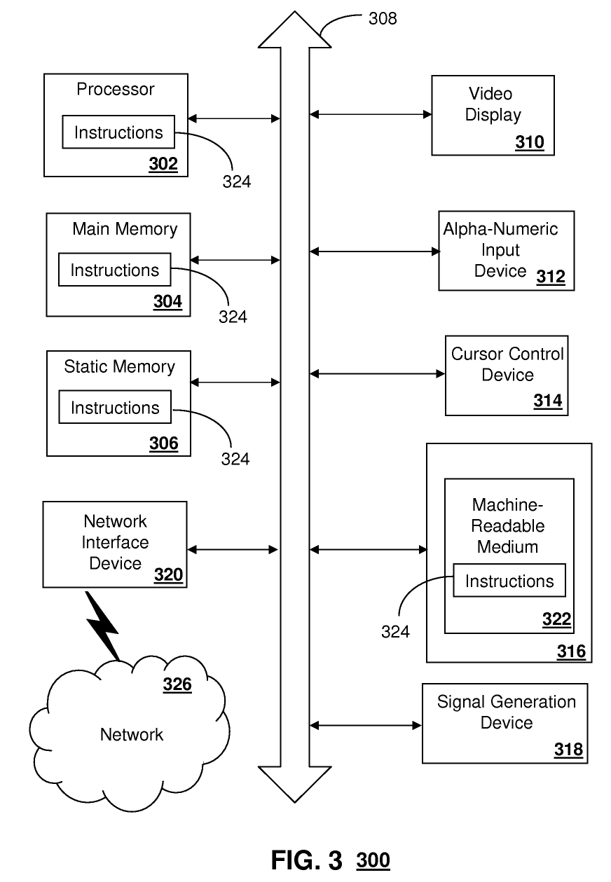

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a mass storage medium 316, a signal generation device 318 (e.g., a speaker or remote control) and a network interface device 320.

The mass storage medium 316 may include a computer-readable storage medium 322 on which is stored one or more sets of instructions (e.g., software 324) embodying any one or more of the methodologies or functions described herein, including those methods illustrated above. The computer-readable storage medium 322 can be an electromechanical medium such as a common disk drive, or a mass storage medium with no moving parts such as Flash or like non-volatile memories. The instructions 324 may also reside, completely or at least partially, within the main memory 304, the static memory 306, and/or within the processor 302 during execution thereof by the computer system 300. The main memory 304 and the processor 302 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the computer-readable storage medium 322 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising at least one among a group of computer instructions for:
monitoring a response time to queries submitted to a Telephone Number Mapping (ENUM) system by one or more network elements of an IP Multimedia Subsystem (IMS) network;
monitoring a throughput of queries processed by the ENUM system;
monitoring a maximum response time to queries submitted to the ENUM system;
monitoring a minimum response time to queries submitted to the ENUM system;
monitoring an average response time to queries submitted to the ENUM system;
monitoring utilization of resources of the ENUM system; and
monitoring test queries submitted to the ENUM system.

2. The storage medium of claim 1, comprising computer instructions for comparing each of one or more results derived from at least one of said monitoring steps to a corresponding expectancy threshold.

3. The storage medium of claim 2, comprising computer instructions for asserting a fault notice responsive to one or more faults detected from at least one of the one or more results exceeding its corresponding expectancy threshold.

4. The storage medium of claim 3, comprising computer instructions for submitting the fault notice to a service agent managing operations of the ENUM system.

5. The storage medium of claim 3, comprising computer instructions for mitigating operations of the ENUM system according to the fault notice.

6. The storage medium of claim 3, comprising computer instructions for redistributing resources of the ENUM system to counteract one or more effects caused by the one or more faults.

7. The storage medium of claim 6, wherein the resources comprise at least one among one or more zones, one or more domain name service (DNS) servers, and one or more lightweight directory access protocol (LDAP) servers.

8. The storage medium of claim 1, wherein at least one of the one or more network elements of the IMS network comprises a Serving Call Session Control Function (S-CSCF), and wherein the storage medium comprises computer instructions for:
directing the S-CSCF to perform one among the aforementioned monitoring steps with the ENUM system; and
receiving from the S-CSCF one or more results associated with the monitoring step performed by the S-CSCF.

9. The storage medium of claim 1, wherein the computer-readable storage medium operates in at least one among the ENUM system, and the one or more network elements of IMS network.

10. A Telephone Number Mapping (ENUM) system, comprising a subsystem to:
monitor one or more operations of the ENUM system; and
generate a fault notice responsive to detecting one or more faults in the operations monitored.

11. The ENUM system of claim 10, wherein the subsystem performs at least one among:
monitoring a response time to queries submitted to the ENUM system by one or more network elements of an IP Multimedia Subsystem (IMS) network;
monitoring a throughput of queries processed by the ENUM system;
monitoring a maximum response time to queries submitted to the ENUM system;
monitoring a minimum response time to queries submitted to the ENUM system;
monitoring an average response time to queries submitted to the ENUM system; and
monitoring utilization of resources of the ENUM system.

12. The ENUM system of claim 10, wherein the subsystem compares each of one or more results derived from the operations monitored to a corresponding expectancy threshold.

13. The ENUM system of claim 12, wherein the subsystem asserts a fault notice responsive to one or more faults detected from the one or more results exceeding its corresponding expectancy threshold.

14. The ENUM system of claim 13, wherein the subsystem submits the fault notice to a service agent managing operations of the ENUM system.

15. The ENUM system of claim 13, wherein the subsystem mitigates operations of the ENUM system according to the fault notice.

16. The ENUM system of claim 13, wherein the subsystem redistributes resources of the ENUM system to counteract one or more effects caused by the one or more faults.

17. The ENUM system of claim 16, wherein the resources comprise at least one among one or more zones, one or more domain name service (DNS) servers, and one or more lightweight directory access protocol (LDAP) servers.

18. A network element of an IP Multimedia Subsystem (IMS) network, comprising a controller element to monitor operations of a Telephone Number Mapping (ENUM) system.

19. The network element of claim 18, wherein the network element corresponds to at least one among Serving Call Session Control Function (S-CSCF), Interrogating CSCF (I-CSCF), a Proxy CSCF (P-CSCF), a Home Subscriber Server (HSS), and an Application Server (AS).

20. The network element of claim 18, wherein the controller element performs at least one among:
monitoring a duration to receive a response from the ENUM system after submitting an E.164 number translation query to the ENUM system;
monitoring a throughput of queries processed by the ENUM system;
monitoring a maximum response time to queries submitted to the ENUM system;
monitoring a minimum response time to queries submitted to the ENUM system;
monitoring an average response time to queries submitted to the ENUM system; and
monitoring utilization of resources of the ENUM system.

21. The network element of claim 18, wherein the controller element:
detects a fault from the monitored operations; and
submits a notice associated with the fault to at least one among a service agent of the ENUM system, and a system monitoring operations of the IMS network.

22. The network element of claim 18, wherein the controller element monitors a propagation delay associated with transmitting an E.164 number translation query to the ENUM system receiving a SIP URI therefrom, and translating the SIP URI to an IP address.

23. The network element of claim 22, wherein the controller element generates a notification that identifies an ENUM cluster failure or that requests a check of an ENUM load balancer when no response is received from the ENUM system.

24. The network element of claim 22, wherein the controller element generates a notification that identifies a response time and connection status of the ENUM system.
